(19) United States
(12) Patent Application Publication
(10) Pub. No.: US 2025/0141129 A1
(43) Pub. Date: May 1, 2025

(54) CONNECTION STRUCTURE AND TERMINAL BLOCK

(71) Applicant: Yazaki Corporation, Tokyo (JP)

(72) Inventors: Michihiro MORI, Makinohara-shi (JP); Daisuke Yamanashi, Makinohara-shi (JP); Jumpei Hayashi, Kakegawa-shi (JP)

(73) Assignee: Yazaki Corporation, Tokyo (JP)

(21) Appl. No.: 18/899,510

(22) Filed: Sep. 27, 2024

(30) Foreign Application Priority Data
Nov. 1, 2023 (JP) 2023-187540

(51) Int. Cl. H01R 9/24

(52) U.S. Cl. CPC H01R 9/2416

(57) ABSTRACT

A connection structure is a structure for connecting a conductive busbar 10 to a connection target. The connection structure 100 includes a connection portion 18 that is provided on the busbar 10 and serves as a connection location for the connection target, and a holder 30 that is configured to accommodate foreign matters that arise in the connection portion 18. The connection portion 18 includes a screw fastening portion A between a bolt 16 that extends in a plate thickness direction of the busbar 10 and a nut 17 into which the bolt 16 is screwed. In the housing 30, a plurality of spaces, i.e., a first recessed portion 36 and a second recessed portion 37, containing the foreign matters and partition portions, i.e., a first partition portion P1 and a second partition portion P2, partitioning the plurality of spaces constitute a labyrinth structure 38.

### TECHNICAL FIELD

The present disclosure relates to a connection structure and a terminal block.

### BACKGROUND

Conventionally, a connection structure for fastening bus bars connected to an electronic component to terminals of external connectors is known (see, for example, Patent Document 1). In the terminal connection structure described in Patent Document 1, bus bars accommodated in a storage case and connector terminals that are inserted into the storage case from the outside are fastened by bolts.

### RELATED ART

### Patent Document

Patent Document 1: JP2011187933A

### SUMMARY OF THE INVENTION

### Problem to be Solved by the Invention

In the above-described terminal block, foreign matters such as wear debris are generated in the portions where the bolts are fastened, and the foreign matters can cause a problem in that they diffuse inside the storage case.

It is an object of the present invention to provide a connection structure and a terminal block capable of alleviating the diffusion of foreign matters.

### Solution to Problem

In order to solve the above problems and achieve the object, a connection structure for connecting a conductive busbar to a connection target, includes a connection portion that is provided on the busbar and serves as a connection location for the connection target; and a diffusion prevention portion that is configured to accommodate foreign matters that arise in the connection portion, wherein the connection portion includes a screw fastening portion between a fastening member that extends in a plate thickness direction of the busbar and a fastening counterpart member into which the fastening member is screwed, and wherein in the diffusion prevention portion, a plurality of spaces configured to contain the foreign matters and partition portions partitioning the plurality of spaces constitute a labyrinth structure.

The terminal block includes the above-described connection structure.

### Advantageous Effects of the Invention

According to the present disclosure, a connection structure and a terminal block capable of alleviating the diffusion of foreign matters can be provided.

### BRIEF DESCRIPTION OF THE DRAWINGS

FIG. 1 is an exploded perspective view of a terminal block having a connection structure.

FIG. 2 is a perspective view of the terminal block after assembly is completed.

FIG. 3 is a cross-sectional view taken along line A-A in FIG. 2.

FIG. 4 is an enlarged perspective view of a holder that constitutes the connection structure.

### DETAILED DESCRIPTION OF THE EXEMPLARY EMBODIMENT

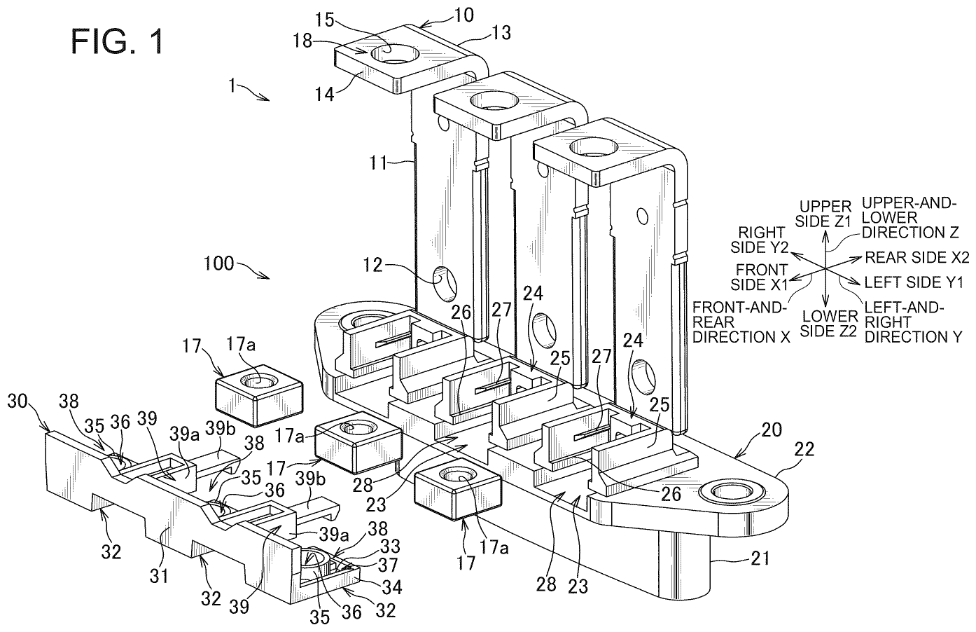

An embodiment of the present invention will now be described with reference to FIGS. 1 to 4. In the present embodiment, in the drawings, arrows X, Y, and Z indicate directions perpendicular to one another. The central axis direction, i.e., the axial direction, of a second insertion hole 15 (insertion hole) in a housing 20 (described later) is indicated by an arrow Z and is referred to as an “upper-and-lower direction Z”. One side of the upper-and-lower direction Z is referred to as an “upper side Z1”, and the other side is referred to as a “lower side Z2.” The front-and-rear direction of the housing 20 is referred to as a “front-and-rear direction X (orthogonal direction)”, and one side of the front-and-rear direction X is referred to as a “front side X1”, and the other side is referred as a “rear side X2”. A width direction of the housing 20 is referred to as a “left-and-right direction Y (orthogonal direction)”, one side of the left-and-right direction Y is referred to as a “left side Y1”, and the other side is referred to as a “right side Y2”. These definitions of direction are merely for convenience of explanation and do not limit the direction of the terminal block 1 during manufacture and use. In addition, in order to avoid complication, some of the reference numerals are omitted for components provided in multiple numbers in similar configurations, such as busbars 10, installation recessed portions 28, receiving portions 32, and the like, described later.

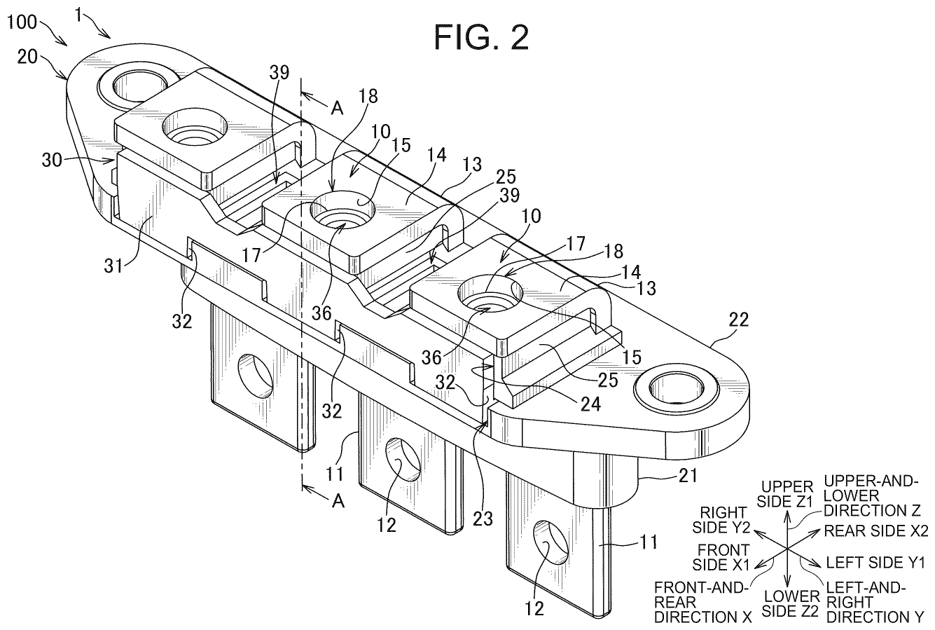

The terminal block 1 according to the present embodiment is a type of connector that is attached to an electrical device, and connects one electrical device (e.g., a battery) and another electrical device (e.g., an inverter) mounted on a vehicle such as an electric automobile, as connection targets. As illustrated in FIGS. 1 and 2, the terminal block 1 includes busbars 10 and a housing 20 that holds the busbars 10. The busbars 10 are formed in a plate shape using a conductive metal material, and in the present embodiment, three busbars 10 are arranged side by side in the left-and-right direction Y. The busbar 10 includes a vertical plate portion 11 that extends in the upper-and-lower direction Z, and is formed with a first connection hole 12 that penetrates the lower end portion of the vertical plate portion 11 in the front-and-rear direction X. A screw member (not illustrated) is inserted into the first connection hole 12, and the busbar 10 is connected to a terminal or the like of an electric wire that is connected to one of the electric devices serving as the connection target described above via the screw member.

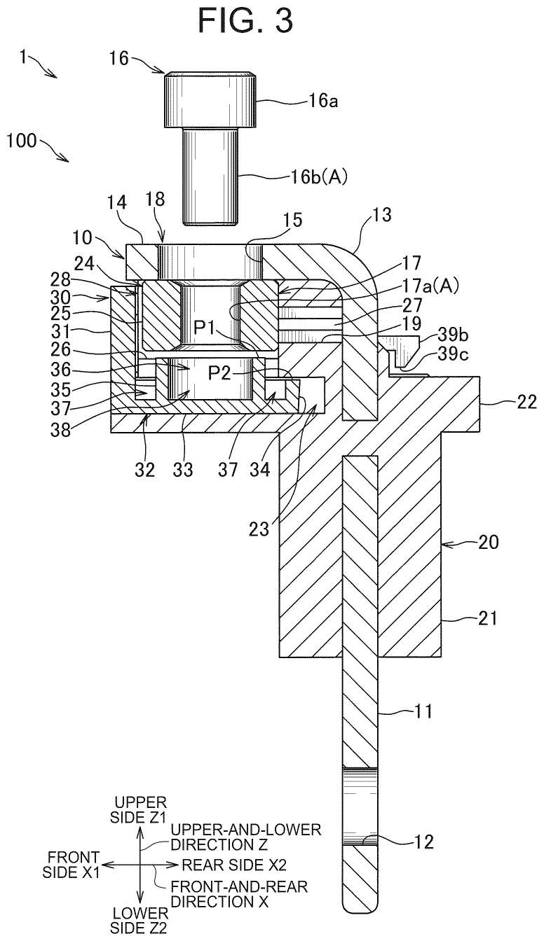

An upper end portion of the vertical plate portion 11 is bent toward the front side X1 to form a bent portion 13, and a horizontal plate portion 14 extending toward the front side X1 is continuous with the tip of bent portion 13. A second insertion hole 15 (insertion hole) is formed in the horizontal plate portion 14, penetrating in the upper-and-lower direction Z (i.e., the plate thickness direction). The second insertion hole 15 serves as a connection location for a terminal of an electric wire that is connected to another electric device among the electric devices serving as the connection target described above, and constitutes a connection portion in the present embodiment, allowing insertion of a bolt 16 (see FIG. 3) serving as a fastening member described below. As illustrated in FIG. 3, the bolt 16 has a head portion 16a arranged on the upper side Z1 (one side in the axial line direction) of the busbar 10, and a male screw portion 16b inserted into the second insertion hole 15 and extending in the upper-and-lower direction Z. In the present embodiment, the bolt 16 is composed of the head portion 16a and the male screw portion 16b, but the present disclosure is not limited thereto, and a flange bolt having a flange portion that protrudes outward in the radial direction between the head portion 16a and the male screw portion 16b may also be used.

A nut 17 serving as a fastening counterpart member is disposed on the lower end portion side of the male screw portion 16b. The nut 17 has a roughly rectangular parallelepiped outer shape, and a lower end portion of the male screw portion 16b is screwed into a female screw portion 17a formed in the central portion. The threaded portion of the male screw portion 16b and the female screw portion 17a constitutes a screw fastening portion A in the present embodiment. With the bolts 16 and the nuts 17 configured in this manner, for example, round terminals of electric wires to be connected to the electric device are connected to the busbars 10. The above-described second insertion hole 15 and the screw fastening portion A constitute a connection portion 18 of the present embodiment.

The housing 20 is formed using a resin material. The housing 20 includes a support portion 21 that covers an outer surface of the vertical plate portion 11 of the busbar 10, and a main body portion 22 in a plate shape that extends in a front-and-rear direction X and a left-and-right direction Y at an upper end portion of the support portion 21. The support portion 21 is formed in a cylindrical shape extending in the upper-and-lower direction Z. Three busbars 10 are inserted in the upper-and-lower direction Z into the support portion 21 and are fixed in a state in which their outer surfaces are covered. Various configurations can be used to fix the busbars 10. For example, through holes (not illustrated) can be formed in support portion 21 and the busbars 10 can be inserted into the through holes and then fixed, or the busbars 10 and the support portion 21 can be integrated by molding. A holder accommodating portion 23 is formed on the top surface of the main body portion 22 and opens to the upper side Z1 and the front side X1 (one side in the orthogonal direction).

Three holder accommodation portions 23 corresponding to the number of busbars 10 are formed, and are lined up in the left-and-right direction Y, and a holder 30 (diffusion prevention portion) described later is accommodated inside the holder accommodation portions 23. A nut accommodation portion 24 is formed in the upper edge portion of the holder accommodation portion 23. The nut accommodation portion 24 has side walls 25 that rises from the upper edge portion of the holder accommodation portion 23 to the upper side Z1, and like the holder accommodation portion 23, is open to the upper side Z1 and the front side X1. The nut accommodation portion 24 accommodates the nut 17. The first support protrusions 26 protruding inward in the left-and-right direction Y are formed on the lower end portions of the inner surfaces of the side walls 25 situated on the left side Y1 and right side Y2 among the side walls 25 of the nut accommodation portion 24.

The first support protrusion 26 abuts against the underside of the nut 17 and supports the nut 17 toward the upper side Z1. Furthermore, the second support protrusions 27 protruding inward in the left-and-right direction Y are formed in the central portions of the inner surfaces of the side walls 25 situated on the left side Y1 and the right side Y2. The second support protrusions 27 abut against the sides of the nut 17 and restrict the displacement of the nut 17 in the left-and-right direction Y. Y. The holder accommodation portion 23 and the nut accommodation portion 24 formed in this manner constitute an installation recessed portion 28 that opens to the front side X1 of the housing 20. The nut 17 is housed on the upper side Z1 of the installation recessed portion 28, and the holder 30 is accommodated on the lower side Z2 of the installation recessed portion 28.

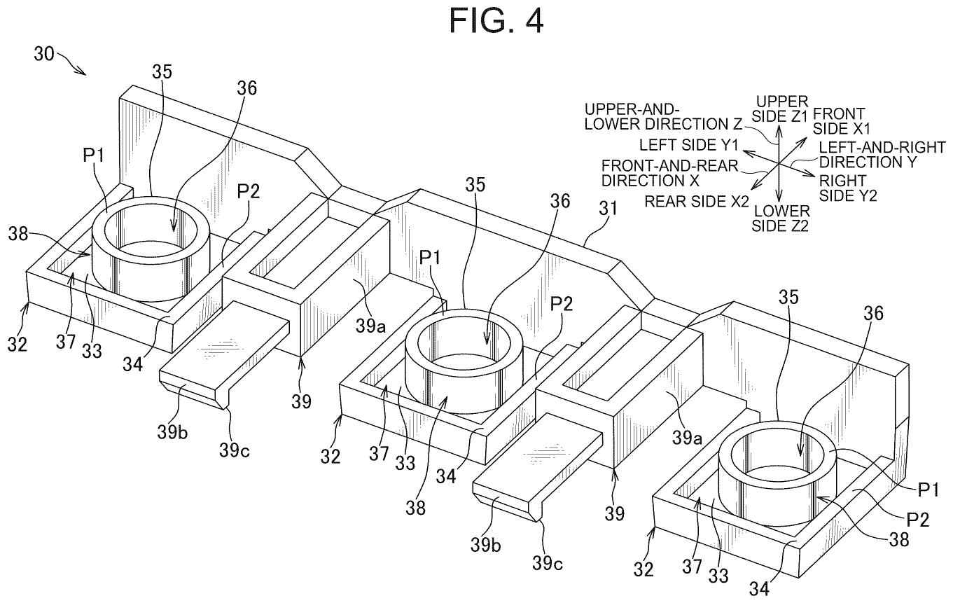

The holder 30 is the diffusion prevention portion of the present embodiment that prevents foreign matters from diffusing into the housing 20 by accommodating foreign matters that arise in the above-mentioned connection portions 18 (the second insertion holes 15 and the screw fastening portions A), and is formed using a resin material and is detachably attached to the installation recessed portion 28. As illustrated in FIG. 4, the holder 30 has a shielding portion 31 in a plate shape extending in the left-and-right direction Y and the upper-and-lower direction Z. The shielding portion 31 is a portion that shields the opening on the front side X1 of the above-described installation recessed portion 28, and its dimension in the upper-and-lower direction Z is formed to be approximately the same as the dimension in the upper-and-lower direction Z of the installation recessed portion 28. Receiving portions 32 that protrude toward the rear side X2 are formed on the surface of the shielding portion 31 facing the rear side X2. The receiving portions 32 are the portions that are accommodated in the holder accommodation portions 23 of the installation recessed portions 28, and three receiving portions 32 are formed to match the number of the installation recessed portions 28, and are arranged at intervals in the left-and-right direction Y.

The receiving portion 32 includes a bottom plate 33 in a substantially rectangular plate shape, a frame portion 34 rising from the edge of the bottom plate 33 toward the upper side Z1, and a cylindrical portion 35 provided in the center of the bottom plate 33. In the present embodiment, the cylindrical shape 35 is formed in a cylindrical shape, extends to the upper side Z1, and opens to the upper side Z1. As illustrated in FIG. 3, when the receiving portions 32 are accommodated in the holder accommodation portions 23 and the nuts 17 are accommodated in the nut accommodation portions 24, the center axes of the cylindrical shapes 35 are coaxial with the center axes of the second insertion holes 15 and the center axes of the nuts 17. In this state, the interior of the cylindrical shape 35 is disposed at least on the lower side Z2 of the screw fastening portion A and is open toward the connection portion 18, and the interior of the cylindrical shape 35 constitutes the first recessed portion 36 (space) of the present embodiment. In addition, in the receiving portion 32, the area between the outer surface of the cylindrical shape 35 and the inner surface of the frame portion 34 covers the first recessed portion 36 around the center axis (axial line) of the screw fastening portion A and, like the first recessed portion 36, is open toward the connection portion 18, constituting the second recessed portion 37 (space) according to the present embodiment.

As illustrated in FIG. 4, on the surface of the shielding portion 31 facing the rear side X2, a connection portion 39 protruding toward the rear side X2 is formed between receiving portions 32. Two connection portions 39 are formed in total and are portions that fix the holder 30 installed in the installation recessed portions 28 to the housing 20, and are aligned in the left-and-right direction Y. The connection portion 39 includes a connection body 39a and an insertion piece 39b extending from the rear end of the connection body 39a toward the rear side X2. The connection body 39a is formed in a generally rectangular rod shape and extends to the rear side X2. With the holder 30 installed in the installation recessed portions 28, the connection bodies 39a are sandwiched in the left-and-right direction Y by the side walls 25 of the nut accommodation portions 24, and displacement in the left-and-right direction Y is restricted. The insertion pieces 39b are formed in a plate shape, extend to the rear side X2, and are inserted into through holes 19 (see FIG. 3) in the front-and-rear direction X provided in the housing 20. Claw portions 39c are formed at the rear end portions of the insertion pieces 39b, protruding toward the lower side Z2. The claw portions 39c function as stoppers that prevent the insertion pieces 39b from slipping out of the through holes.

With this configuration, when the holder 30 is installed in the installation recessed portion 28, the center axis of the second insertion hole 15, the center axis of the nut 17, and the center axis of the cylindrical shape 35 are coaxial, as described above. Then, the first recessed portion 36 and the second recessed portion 37 are open toward the connection portion 18. Then, as illustrated in FIG. 3, the shielding portion 31 overlaps with the opening on the front side X1 of the installation recessed portion 28 when viewed from the front side X1. That is, the shielding portion 31 shields the opening of the installation recessed portion 28. Furthermore, with this configuration, even if foreign matters such as wear debris generated in connection portion 18 diffuse to the lower side Z2, the foreign matters fall into the first recessed portion 36 and are contained within the first recessed portion 36, thereby preventing the diffusion of foreign matters.

Furthermore, if the foreign matters contained in the first recessed portion 36 fly up and otherwise diffuse outside the first recessed portion 36, the second recessed portion 37, which covers the first recessed portion 36, contains those foreign matters, thereby preventing their diffusion. Furthermore, with the formation of the first recessed portion 36 and the second recessed portion 37, foreign matters that are diffused from the connection portion 18 without being contained in the first recessed portion 36 can be directly contained in the second recessed portion 37. Furthermore, even if the foreign matters contained in the second recessed portion 37 fly up and otherwise diffuse outside the second recessed portion 37, the foreign matters can be contained in the first recessed portion 36. In other words, the holder 30 has multiple spaces to accommodate foreign matters, and the diffusion of foreign matters is prevented in two stages, i.e., in the first recessed portion 36 and the second recessed portion 37.

The boundary between the first recessed portion 36 and the second recessed portion 37 constitutes a first partition portion P1 (partition portion) that separates the above-mentioned multiple spaces. The boundary between the second recessed portion 37 and the outside of the holder 30 constitutes a second partition portion P2 (partition portion) that separates the above-mentioned multiple spaces. By establishing the first partition portion P1 and the second partition portion P2, the hypothetical diffusion path of foreign matters becomes a complex diffusion path that overcomes both the first partition portion P1 and the second partition portion P2. As a result, the rate at which foreign matters diffuse slows as they cross portion P1 of the first partition and portion P2 of the second partition, thereby inhibiting the diffusion of foreign matters. In the present embodiment, the first recessed portion 36 and the second recessed portion 37 (the multiple spaces for accommodating foreign matters) and the first partition portion P1 and the second partition portion P2 (partition portions) that separate the multiple spaces are collectively referred to as a labyrinth structure 38.

In order to reliably accommodate foreign matters that may arise in the connection portion 18, it is preferable that the opening area of the first recessed portion 36 be formed larger than the opening area of the nut 17. In addition, it is preferable that the dimension from the end of the left side Y1 to the end of the right side Y2 and the dimension from the end of the front side X1 to the end of the rear side X2 of the second recessed portion 37, i.e., the dimension in the orthogonal directions orthogonal to the upper-and-lower direction Z, be set larger than the dimension in the same direction of the nut 17.

The connection portion 18 and the holder 30 configured as described above constitute a connection structure 100 that connects the busbar 10 to a connection target. Specifically, the connection structure 100 is a connection structure that connects the conductive busbar 10 to the connection target, and includes a connection portion 18 that is provided on the busbar 10 and serves as a connection location for the connection target. The connection structure 100 also includes a holder 30 that is configured to accommodate foreign matters that arise in the connection portion 18. The connection portion 18 includes a screw fastening portion A between the bolt 16 and the nut 17. The holder 30 has multiple spaces, i.e., the first recessed portion 36 and the second recessed portion 37, for housing foreign matters, and partition portions, i.e., the first partition portion P1 and the second partition portion P2, which separate the multiple spaces. The first recessed portion 36, the second recessed portion 37, the first partition portion P1, and the second partition portion P2 constitute the labyrinth structure 38.

Next, the assembly of the terminal block 1 will be explained with reference to FIG. 1 and FIG. 2. FIG. 1 is an exploded perspective view of a terminal block 1 having a connection structure 100. FIG. 2 is a perspective view of the terminal block 1 after assembly is completed. First, the busbar 10 and the housing 20 are integrally formed by molding. Then, the nuts 17 are installed in the nut accommodation portions 24 of the respective installation recessed portions 28. Next, the holder 30 is prepared and positioned such that an end portion of the rear side X2 of the receiving portion 32 faces, in the front-and-rear direction X, the opening of the holder accommodation portion 23 of the installation recessed portion 28 of the housing 20. Then, in this state, the holder 30 is slid to the rear side X2 and assembled into the holder accommodation portion 23. At this time, the receiving portions 32 are inserted into the respective holder accommodation portions 23. At this time, the connection bodies 39a of the connection portions 39 are inserted between the side wall 25 of one nut accommodation portion 24 and the side wall 25 of another nut accommodation portion 24. Additionally, the insertion piece 39b of each connection portion 39 is inserted into the corresponding through hole 19 of the housing 20. Then, when the center axis of the second insertion hole 15, the nut 17, and the cylindrical shape 35 are coaxial, the assembly of the holder 30 is complete.

This completes the assembly of the terminal block 1 as illustrated in FIG. 2. In this state of terminal block 1, the horizontal plate portion 14 of the busbar 10 and the connection target are then connected and fixed by screwing the bolt 16 and the nut 17 together. During this process, foreign matters such as wear debris may be generated in the screw fastening portion A. However, as mentioned above, the provision of the labyrinth structure 38 prevents the diffusion of foreign matters. Note that, unlike the present embodiment, it is also possible to consider, for example, closing the opening to reduce the diffusion of wear debris by crimping a member such as a cap to the opening on of each nut 17 on the opposite side from the bolt 16. However, in this case, a dedicated crimping machine is required, and three nuts 17 and three caps, totaling six components, are required, making it cumbersome to manufacture the terminal block 1. In contrast, according to the present embodiment, it is possible to reduce the diffusion of foreign matters arising from the three nuts 17 by just preparing one holder 30. Furthermore, as described above, the holder 30 can be assembled to the housing 20 by inserting it into the holder accommodation portion 23, so no special equipment or the like is required for assembly. Therefore, the number of components of the terminal block 1 can be reduced, and the manufacturing cost of the terminal block 1 can be reduced.

According to the embodiment described above, by providing the labyrinth structure 38 in the holder 30 (diffusion prevention portion), foreign matters such as wear debris diffusing from the connection portion 18, such as the screw fastening portion A, can be contained in the first recessed portion 36 (space). In addition, with the labyrinth structure 38, the foreign matters diffused around the first recessed portion 36 can be contained into the second recessed portion 37 (space). This structure makes it possible to prevent the diffusion of foreign matters in two stages. In addition, with the labyrinth structure 38, the hypothetical diffusion of foreign matters can be made into a complex diffusion path that crosses both the first partition portion P1 and the second partition portion P2 (partition portion). Therefore, the first partition portion P1 and the second partition portion P2 can slow down the diffusion rate of foreign matters and alleviate the diffusion of foreign matters. Therefore, the connection structure 100 that can alleviate the diffusion of foreign matters can be provided.

Furthermore, according to the above-described embodiment, in a structure in which the busbar 10 is sandwiched in the plate thickness direction between the head portion 16a of the bolt 16 and the nut 17, the diffusion of foreign matters can be alleviated by the holder 30 (diffusion prevention portion) positioned on the lower side Z2 (the other side in the axial line direction) of the nut 17.

Furthermore, according to the above-described embodiment, because the opening area of the first recessed portion 36 is larger than the opening area of the nut 17, foreign matters that fall from the female screw portion 17a of the nut 17 to the lower side can be reliably contained in the first recessed portion 36. In addition, the dimensions of the front-and-rear direction X and the left-and-right direction Y (orthogonal direction) of the second recessed portion 37 are set larger than the dimensions of the front-and-rear direction X and the left-and-right direction Y (orthogonal direction) of the nut 17. Because of this setup, even if there are foreign matters that cannot be contained in the first recessed portion 36, those foreign matters can be reliably contained on the lower side Z2 of the nut 17. This further prevents diffusion of foreign matters.

According to the embodiment described above, the terminal block 1 can be configured using the connection structure 100 that can alleviate the diffusion of foreign matters.

Furthermore, according to the above-described embodiment, the diffusion of foreign matters can be prevented by accommodating the nut 17 and the holder 30 in the installation recessed portion 28 of the housing 20. In this case, the shielding portion 31 of the holder 30 overlaps with the opening of the front side X1 of the installation recessed portion 28 when viewed from the front side X1 (one side in the orthogonal direction), thereby making the opening area of the said opening a maximum of 0. Therefore, the diffusion of foreign matters from the opening of the installation recessed portion 28 can be prevented.

The above describes in detail the embodiment of the terminal block 1 and the connection structure 100 with reference to the drawings. However, the specific configuration is not limited to thereto, and the present invention includes design changes and the like that do not deviate from the gist of the present invention.

For example, in the present embodiment, the first recessed portion 36 formed inside the cylindrical shape 35 and the second recessed portion 37 formed between the outer surface of cylindrical shape 35 and the inner surface of frame portion 34 constitute multiple spaces. The first partition portion P1 and the second partition portion P2 constitute a partition portion. The space and the partition portion constitute the labyrinth structure 38. However, the structure of the labyrinth structure 38 is not limited thereto. That is, as long as there are multiple spaces for accommodating foreign matters and partition portions for dividing the multiple spaces, the shape and number of the spaces can be changed as appropriate. In the present embodiment, the screw fastening portion A is configured by the male screw portion 16b of the bolt 16 and the female screw portion 17a of the nut 17, but the structure of the screw fastening portion A is not limited thereto. For example, a female screw portion may be formed on the inner circumferential surface of the second insertion hole 15, and the female screw portion and the male screw portion 16b may constitute the screw fastening portion A. In addition, the nut 17 is separate from the housing 20, but the nut 17 may be provided integrally with the housing 20. Similarly, the bolt 16 may be provided integrally with the housing 20.

Furthermore, in the present embodiment, the shielding portion 31 is provided on the holder 30, and the dimension of the shielding portion 31 in the upper-and-lower direction Z is set to be approximately the same as the dimension of the installation recessed portion 28 in the upper-and-lower direction Z. However, the dimension of the shielding portion 31 in the upper-and-lower direction Z can be changed as appropriate. Also, the shielding portion 31 itself may be omitted. The connection structure 100 of the present embodiment is not limited to the terminal block 1, and can be applied to various configurations including the connection portion 18 that connects the busbar 10 to the connection target, and can achieve the same effects and advantages as the present embodiment.

### LIST OF REFERENCE SIGNS

A screw fastening portion
P1 first partition portion (partition portion)
P2 second partition portion (partition portion)
10 busbar
16 bolt (fastening member)
17 nut (fastening counterpart member)
18 connection portion
30 holder (diffusion prevention portion)
36 first recessed portion (space)
37 second recessed portion (space)
38 labyrinth structure
100 connection structure

What is claimed is:

1. A connection structure for connecting a conductive busbar to a connection target, comprising:
a connection portion that is provided on the busbar and serves as a connection location for the connection target; and
a diffusion prevention portion that is configured to accommodate foreign matters that arise in the connection portion,
wherein the connection portion includes a screw fastening portion between a fastening member that extends in a plate thickness direction of the busbar and a fastening counterpart member into which the fastening member is screwed, and
wherein in the diffusion prevention portion, a plurality of spaces configured to contain the foreign matters and partition portions partitioning the plurality of spaces constitute a labyrinth structure.

2. The connection structure according to claim 1,
wherein the labyrinth structure includes:
a first recessed portion disposed at least on the other side, in an axial line direction, of the screw fastening portion and opening toward the connection portion; and
a second recessed portion covering the first recessed portion around the axial line of the screw fastening portion and opening toward the connection portion,
wherein an inside of the first recessed portion and an inside of the second recessed portion constitute the space, and
a boundary between the first recessed portion and the second recessed portion constitutes the partition portion.

3. The connection structure according to claim 2, wherein the connection portion includes an insertion hole penetrating the busbar in a plate thickness direction,
the fastening member is a bolt that includes:
a head portion provided on one side in the axial line direction with respect to the busbar; and
a male screw portion configured to be inserted into the insertion hole,
the fastening counterpart member is a nut provided on the other side in the axial line direction with respect to the busbar and includes a female screw portion into which the male screw portion is screwed,
the male screw portion and the female screw portion constitute the screw fastening portion, and
the diffusion prevention portion is disposed closer to the other side in the axial line direction than the nut.

4. The connection structure according to claim 3, wherein the plate thickness direction is an upper-and-lower direction,
the one side in the axial line direction is an upper side,
the other side in the axial line direction is a lower side,
an opening area of the first recessed portion is larger than an opening area of the nut, and
a dimension of the second recessed portion in an orthogonal direction orthogonal to the axial line direction is greater than a dimension of the nut in the orthogonal direction.

5. A terminal block comprising the connection structure according to claim 4.

6. The terminal block according to claim 5, comprising a housing configured to hold the busbar,
wherein the housing is provided with an installation recessed portion that is open to one side in the orthogonal direction,
the nut is accommodated on the upper side of the installation recessed portion,
the diffusion prevention portion is accommodated on the lower side of the installation recessed portion, and
the diffusion prevention portion is provided with a shielding portion that overlaps with the opening of the installation recessed portion when viewed from the one side in the orthogonal direction.
